(19) United States
(12) Patent Application Publication
(10) Pub. No.: US 2023/0365456 A1
(43) Pub. Date: Nov. 16, 2023

(54) GLASS CERAMIC AND CHEMICALLY STRENGTHENED GLASS

(71) Applicant: AGC INC., Tokyo (JP)

(72) Inventors: Shigeki SAWAMURA, Chiyoda-ku (JP); Qing LI, Chiyoda-ku (JP); Hitomi FURUTA, Chiyoda-ku (JP); Shusaku AKIBA, Chiyoda-ku (JP)

(73) Assignee: AGC INC., Tokyo (JP)

(21) Appl. No.: 18/355,545

(22) Filed: Jul. 20, 2023

Related U.S. Application Data
(63) Continuation of application No. PCT/JP2022/004141, filed on Feb. 2, 2022.

(30) Foreign Application Priority Data
Feb. 8, 2021 (JP) 2021-018363

(51) Int. Cl. C03C 10/00

(52) U.S. Cl. CPC C03C 10/0009; C03C 10/0054

(57) ABSTRACT

The present invention is a glass ceramic including a crystal and a residual glass, in which the residual glass has a Young's modulus parameter ER of 75 or more, the Young's modulus parameter ER being calculated based on the following formula: ER=62.2×[SiO₂]+134.9×[Al₂O₃]+121.7×[B₂O₃]+33.0×[P₂O₅]+72.6×[MgO]+121.5×[CaO]+43.7×[SrO]+38.6×[BaO]+84.0×[Li₂O]+26.2×[Na₂O]+17.8×[K₂O]+156.8×[ZrO₂]+154.3×[TiO₂]+74.7×[La₂O₃]+80.3×[Y₂O₃]+54.3×[ZnO].

### CROSS-REFERENCE TO RELATED APPLICATIONS

This is a continuation of International Application No. PCT/JP2022/004141 filed on Feb. 2, 2022, and claims priority from Japanese Patent Application No. 2021-018363 filed on Feb. 8, 2021, the entire content of which is incorporated herein by reference.

### TECHNICAL FIELD

The present invention relates to a glass ceramic and a chemically strengthened glass.

### BACKGROUND ART

A chemically strengthened glass is used for a cover glass or the like of a mobile terminal. The chemically strengthened glass is obtained by, for example, bringing a glass into contact with a molten salt containing alkali metal ions to cause ion exchange between the alkali metal ions in the glass and alkali metal ions in the molten salt, thereby forming a compressive stress layer on the glass surface, and is excellent in strength.

However, for example, when the mobile terminal is dropped on a paved road, the cover glass is easily broken even if the cover glass is made of the chemically strengthened glass. Therefore, it has been studied to use glass ceramics having higher strength than an amorphous glass as a cover glass. If glass ceramics excellent in transparency and capable of being chemically strengthened can be obtained, it is considered promising for various cover glass applications.

### CITATION LIST

### Patent Literature

Patent Literature 1: WO2019/022034

### SUMMARY OF INVENTION

### Technical Problem

Although glass ceramics are excellent in strength compared to an amorphous glass, it is not easy to obtain high strength such as being resistant to breakage even if dropped on a road. In the glass ceramics, since the glass contains a high-strength crystal, higher strength than an original glass (base glass) can be obtained.

However, a glass is a brittle material, and if the brittle glass remains around the high-strength crystal in the glass ceramics, a crack that is a starting point of fracture is likely to occur in the residual glass, and sufficient strength cannot be obtained. If a content of the crystal is excessively increased in order to increase the strength of the glass ceramics, the transparency may decrease.

Therefore, an object of the present invention is to provide a glass ceramic having excellent impact resistance.

### Solution to Problem

As a result of studies focusing on a residual glass composition of the glass ceramics, the present inventors have found that the above problems can be solved by setting the residual glass composition within a specific range, and have made the present invention.

The present invention is a glass ceramic including a crystal and a residual glass,
in which the residual glass has a Young's modulus parameter ER of 75 or more, the Young's modulus parameter ER being calculated based on the following formula:

ER=62.2×[SiO₂]+134.9×[Al₂O₃]+121.7×[B₂O₃]+33.0×[P₂O₅]+72.6×[MgO]+121.5×[CaO]+43.7×[SrO]+38.6×[BaO]+84.0×[Li₂O]+26.2×[Na₂O]+17.8×[K₂O]+156.8×[ZrO₂]+154.3×[TiO₂]+74.7×[La₂O₃]+80.3×[Y₂O₃]+54.3×[ZnO],
provided that [SiO₂], [Al₂O₃], [B₂O₃], [P₂O₅], [MgO], [CaO], [SrO], [BaO], [Li₂O], [Na₂O], [K₂O], [ZrO₂], [TiO₂], [La₂O₃], [Y₂O₃], and [ZnO] are respectively contents in the residual glass of SiO₂, Al₂O₃, B₂O₃, P₂O₅, MgO, CaO, SrO, BaO, Li₂O, Na₂O, K₂O, ZrO₂, TiO₂, La₂O₃, Y₂O₃, and ZnO, in terms of mol % based on oxides.

The present invention provides a chemically strengthened glass including a compressive stress layer on a surface thereof, and
having a surface compressive stress of 200 MPa or more and a depth of a compressive stress layer of 80 μm or more,
in which the chemically strengthened glass is a glass ceramic including a crystal and a residual glass,
the residual glass has a Young's modulus parameter ER of 75 or more, the Young's modulus parameter ER being calculated based on the following formula:

ER=62.2×[SiO₂]+134.9×[Al₂O₃]+121.7×[B₂O₃]+33.0×[P₂O₅]+72.6×[MgO]+121.5×[CaO]+43.7×[SrO]+38.6×[BaO]+84.0×[Li₂O]+26.2×[Na₂O]+17.8×[K₂O]+156.8×[ZrO₂]+154.3×[TiO₂]+74.7×[La₂O₃]+80.3×[Y₂O₃]+54.3×[ZnO],
provided that [SiO₂], [Al₂O₃], [B₂O₃], [P₂O₅], [MgO], [CaO], [SrO], [BaO], [Li₂O], [Na₂O], [K₂O], [ZrO₂], [TiO₂], [La₂O₃], [Y₂O₃], and [ZnO] are respectively contents in the residual glass of SiO₂, Al₂O₃, B₂O₃, P₂O₅, MgO, CaO, SrO, BaO, Li₂O, Na₂O, K₂O, ZrO₂, TiO₂, La₂O₃, Y₂O₃, and ZnO, in terms of mol % based on oxides.

### Advantageous Effects of Invention

In the glass ceramic of the present invention, the Young's modulus of the residual glass is controlled by setting a composition of the residual glass to a specific range, so that brittleness of the residual glass is controlled to prevent occurrence of a crack that is a starting point of fracture, and the glass ceramic exhibit excellent strength so that the crack is hardly propagated.

### DESCRIPTION OF EMBODIMENTS

In the specification, “to” indicating a numerical range is used in the sense of including the numerical values set forth before and after the “to” as a lower limit value and an upper limit value, unless otherwise specified.

In the specification, an “amorphous glass” and “glass ceramic” are collectively referred to as “glass”.

In the specification, the “amorphous glass” refers to a glass in which a diffraction peak indicating a crystal is not observed by powder X-ray diffraction. The “glass ceramic” is obtained by subjecting the “amorphous glass” to heat treatment to precipitate crystals, and contains crystals.

In the powder X-ray diffraction measurement, measurement is performed with 2θ in a range of 10° to 80° using a CuKα ray, and when a diffraction peak appears, for example, the precipitated crystal is identified by Hanawalt method.

In a case where glass ceramic is obtained by subjecting an amorphous glass to heat treatment, the amorphous glass before the heat treatment may be referred to as a “base glass of glass ceramic”.

In the specification, a “chemically strengthened glass” refers to a glass after chemical strengthening treatment, and a “glass for chemical strengthening” refers to a glass before chemical strengthening treatment.

The glass ceramic includes a crystal phase and a “residual glass”. The “residual glass” is an amorphous portion in the glass ceramic. A composition of the residual glass can be calculated by estimating a crystallization rate by the Rietveld method and removing the amount of crystal from a starting composition of a glass raw material. The crystallization rate can be calculated from the X-ray diffraction intensity by the Rietveld method. The Rietveld method is described in “Crystal Analysis Handbook” edited by the Crystallographic Society of Japan, “Crystal Analysis Handbook” (Kyoritsu Shuppan, 1999. pp. 492-499).

In the specification, a glass composition is expressed in terms of mol % based on oxides unless otherwise specified, and mol % is simply expressed as “%”.

In the specification, “substantially not contained” means that a component has a content less than an impurity level contained in the raw materials and the like, that is, the component is not intentionally added. Specifically, the content is, for example, less than 0.1%.

In the specification, “light transmittance” refers to average transmittance in light having a wavelength of 380 nm to 780 nm. A “haze value” is measured in accordance with JIS K3761: 2000 using a C light source.

A “fracture toughness value” can be measured using a DCDC method (Acta metall. mater. Vol. 43, pp. 3453-3458, 1995).

<Glass Ceramics>

The glass ceramics are obtained by precipitating crystals from a base glass which is an amorphous glass, and contains crystals and a residual glass. Although it is not easy to directly measure a composition of the residual glass, the composition of the residual glass is a composition obtained by removing precipitated crystals from a composition of the base glass.

Research and development of the glass ceramics are often carried out with a focus on precipitated crystals. However, the present inventors have considered that properties of the glass ceramics can be improved by focusing on the composition of residual glass, and have completed the present invention.

The present glass ceramic preferably contains at least one selected from the group consisting of Li₂O, Na₂O, and K₂O in the glass composition. Accordingly, the glass ceramic not only melts easily at a relatively low temperature, but can also be chemically strengthened by ion exchange of alkali ions.

The present glass ceramic is preferably a lithium aluminosilicate glass containing Li₂O. The lithium aluminosilicate glass has excellent chemical strengthening properties, and thus can achieve higher strength by chemical strengthening. Specifically, the lithium aluminosilicate glass preferably contains, for example, 55% or more of SiO₂, 5% or more of Al₂O₃, and 5% or more of Li₂O. With such a composition, high strength can be obtained by chemical strengthening.

The glass composition of the present glass ceramic is the same as a composition of the amorphous glass before crystallization, and thus will be described in the section of the amorphous glass.

A haze value of the present glass ceramic is preferably 1.0% or less, more preferably 0.4% or less, still more preferably 0.2% or less, and particularly preferably 0.15% or less, in terms of a thickness of 0.7 mm. The smaller the haze value is, the more preferable it is. However, when the crystallization rate is decreased or a crystal grain size is reduced in order to decrease the haze value, mechanical strength decreases. In order to increase the mechanical strength, the haze value is preferably 0.02% or more, and more preferably 0.03% or more, in terms of a thickness of 0.7 mm.

Light transmittance of the present glass ceramic is preferably 85% or more, more preferably 87% or more, and still more preferably 90% or more, in terms of a thickness of 0.7 mm. Since the light transmittance is high, visibility is good when used as a cover glass for a display image of a mobile terminal.

The present glass ceramic preferably has a crystallization rate of 10% by mass or more, more preferably 15% by mass or more, and still more preferably 20% or more, from the viewpoint of improving mechanical properties. Further, from the viewpoint of workability of the glass ceramics, the crystallization rate is preferably 90% by mass or less, more preferably 85% by mass or less, and still more preferably 80% by mass or less.

Examples of the crystals contained in the present glass ceramics include lithium metaphosphate, lithium metasilicate, cristobalite, β-spodumene, spodumene solid solution, petalite, β-quartz, spinel, sapphirine, lithium disilicate, mullite, β-eucryptite (solid solution), and zirconia.

The glass ceramics containing such crystals tend to have high transparency. In view of transparency and strength, the crystals contained in the present glass ceramics are particularly preferably lithium phosphate, lithium metasilicate, lithium disilicate, β-spodumene solid solution, petalite, spinel, sapphirine, or zirconia among the crystals. Glass ceramics having excellent chemical durability are obtained by combining these crystals and a preferred residual glass composition.

The present glass ceramics are obtained by subjecting a base glass to be described later to a heat treatment to perform crystallization.

The fracture of a brittle material such as a glass material is basically caused by stress (mainly tensile stress) concentrating on a flaw generated by mechanical contact, and a crack extending from the weakest portion as a starting point, thereby resulting in fracture. A fracture toughness value of the brittle material is an index indicating the difficulty of crack propagation and is an index indicating the strength.

The fracture toughness value is a value represented by KIC=(2γ×E)^{0.5} (γ is fracture surface energy and E is Young's modulus), and as the Young's modulus E increases, the fracture toughness value KIC becomes large. The glass ceramics can improve the strength as a composite by intentionally precipitating crystals in a glass matrix. Specifically, the hardness can be improved by precipitating crystals with high hardness.

The residual glass which is a matrix has low strength and a low fracture toughness value compared to a crystal phase. Occurrence of the crack basically starts from a portion having low strength, that is, a residual glass phase as a starting point, and propagates through the residual glass phase to cause fracture. Therefore, the composition of the residual glass greatly contributes to the brittleness of the glass.

The glass ceramics of the present invention can prevent the occurrence of the crack which become a fracture starting point by controlling the mechanical properties (Young's modulus) of the residual glass as a matrix by the composition, and exhibit excellent strength. In addition, higher strength is obtained by the chemical strengthening treatment. Furthermore, the transparency can be further improved by appropriately selecting crystals to be precipitated.

<Residual Glass>

The present glass ceramic is characterized by the Young's modulus parameter ER calculated from the composition of the residual glass, and accordingly, high strength can be obtained. The Young's modulus parameter ER of the residual glass is calculated based on the following formula:

ER=62.2×[SiO₂]+134.9×[Al₂O₃]+121.7×[B₂O₃]+33.0×[P₂O₅]+72.6×[MgO]+121.5×[CaO]+43.7×[SrO]+38.6×[BaO]+84.0×[Li₂O]+26.2×[Na₂O]+17.8×[K₂O]+156.8×[ZrO₂]+154.3×[TiO₂]+74.7×[La₂O₃]+80.3×[Y₂O₃]+54.3×[ZnO],

provided that [SiO₂], [Al₂O₃], [B₂O₃], [P₂O₅], [MgO], [CaO], [SrO], [BaO], [Li₂O], [Na₂O], [K₂O], [ZrO₂], [TiO₂], [La₂O₃], [Y₂O₃], and [ZnO] are respectively contents in the residual glass of SiO₂, Al₂O₃, B₂O₃, P₂O₅, MgO, CaO, SrO, BaO, Li₂O, Na₂O, K₂O, ZrO₂, TiO₂, La₂O₃, Y₂O₃, and ZnO, in terms of mol % based on oxides.

The Young's modulus parameter ER of the residual glass in the present glass ceramics is 75 or more, preferably 80 or more, more preferably 82 or more, still more preferably 83 or more, and yet still more preferably 85 or more, from the viewpoint of strength. The Young's modulus parameter ER of the residual glass in the present glass ceramics is preferably 100 or less, more preferably 95 or less, and still more preferably 92 or less.

The Young's modulus parameter ER is a parameter derived from a composition analysis result of the residual glass phase, and an ion filling rate and bond dissociation energy of various constituent oxides, and has a positive correlation with the Young's modulus E. As described above, as the Young's modulus E increases, the fracture toughness value KIC becomes large. Therefore, by increasing the Young's modulus parameter ER, it is possible to increase the fracture toughness value, prevent the occurrence of the crack that is a fracture starting point, and improve the strength.

In particular, the characteristics of crack propagation are directly linked to fracture, and fracture stress 6f of the glass can be expressed by the following formula. σf=√(2γE/πc)

In the formula, γ is fracture surface energy, E is Young's modulus, and c is a length of a crack. Since it is very difficult to greatly change the fracture surface energy by changing the composition of the glass, it is very effective to control the Young's modulus parameter ER having a positive correlation with the Young's modulus in order to improve the fracture stress.

The Young's modulus parameter ER can be adjusted by adjusting the content of each composition constituting the formula and crystallization conditions in the residual glass. Specifically, for example, by devising heat treatment conditions, a crystal seed to be precipitated is controlled, and a component with high Young's modulus is left in the residual glass. In particular, ER can be increased by leaving components such as Al₂O₃, B₂O₃, MgO, Li₂O, ZrO₂, and TiO₂ in the residual glass phase. On the other hand, when the crystallization conditions are performed such that a large amount of P₂O₅, Na₂O, and K₂O remains in the residual glass, ER decreases.

The residual glass preferably contains:
30% to 70% of SiO₂;
5% to 30% of Al₂O₃,
0% to 15% of B₂O₃;
0% to 10% of P₂O₅;
0% to 40% of MgO;
0% to 25% of Li₂O;
0% to 15% of Na₂O; and
0% to 15% of ZrO₂.

Hereinafter, a preferred composition of the residual glass will be described.

SiO₂ is an essential component of the glass ceramics of the present invention and is also included in the residual glass. The content of SiO₂ in the residual glass is preferably 30% or more, as weather resistance of the residual glass is improved and thus weather resistance of the glass ceramics is also improved. The content is more preferably 35% or more, and still more preferably 40% or more. In order to improve the mechanical properties of the residual glass, the content is preferably 70% or less. The content is more preferably 67.5% or less, still more preferably 65% or less.

Al₂O₃ is an essential component of the glass ceramics of the present invention and is also included in the residual glass. When the content of Al₂O₃ in the residual glass is 5% or more, the mechanical properties of the residual glass can be improved. In addition, not only chemical durability is improved, but also chemical strengthening is easily performed. The content is more preferably 7.5% or more, and still more preferably 10% or more. In order to lower viscosity of the residual glass composition and facilitate bending of the glass, the content is preferably 30% or less. The content is more preferably 27.5% or less, and still more preferably 25% or less.

B₂O₃ is an optional component that is a component that lowers the viscosity of the residual glass phase and lowers molding viscosity of the glass ceramics, and is also a component that improves mechanical properties. From the viewpoint of the chemical durability of the residual glass and from the viewpoint of preventing composition variation due to volatilization of B₂O₃ at the time of remelting of the glass ceramics, the content thereof is preferably 15% or less, more preferably 12.5% or less, still more preferably 11% or less, particularly preferably 10% or less, and most preferably 5% or less.

P₂O₅ is a component that functions as a nucleation material of the glass ceramics. In addition, P₂O₅ is also a component that improves chemical strengthening ability, and is an optional component. From the viewpoint of chemical durability and mechanical properties of the residual glass, the content of P₂O₅ contained in the residual glass is preferably 10% or less. The content is more preferably 9% or less, still more preferably 8% or less, and yet still more preferably 7% or less.

MgO is an optional component of the glass ceramics and the residual glass. From the viewpoint of polishing workability and chemical durability of the glass ceramics, the content thereof is preferably 40% or less. The content is more preferably 37.5% or less, and still more preferably 35% or less. From the viewpoint of bending workability, the content is preferably 1% or more, more preferably 2% or more, and still more preferably 4% or more.

Li₂O is an optional component of the glass ceramics. If the content of Li₂O in the residual glass is 0.1% or more, the Young's modulus of the residual glass can be improved. The content is more preferably 0.15% or more, and still more preferably 0.2% or more. From the viewpoint of chemical durability of the residual glass phase, the content is preferably 25% or less. The content is more preferably 22.5% or less, and still more preferably 20% or less.

Na₂O is a component for lowering the viscosity of the residual glass, and is an optional component. If the content of Na₂O in the residual glass is 0.1% or more, the effect is obtained. The content is more preferably 0.2% or more, still more preferably 0.3% or more, and yet still more preferably 0.5% or more. From the viewpoint of mechanical properties and chemical durability of the residual glass, the content of Na₂O in the residual glass is preferably 10% or less. The content is more preferably 7.5% or less, and still more preferably 5% or less.

ZrO₂ is a component that not only improves the mechanical properties of the residual glass but also significantly improves the chemical durability, and is an optional component. The content of ZrO₂ in the residual glass is preferably 0.1% or more, more preferably 1% or more, and still more preferably 2% or more. From the viewpoint of molding viscosity of the glass, the content of ZrO₂ in the residual glass is preferably 15% or less. The content is more preferably 12.5% or less, and still more preferably 10% or less.

K₂O is a component capable of lowering the viscosity of the residual glass and is an optional component. The content of K₂O is preferably 10% or less from the viewpoint of the chemical durability of the residual glass. The content is more preferably 7.5% or less, and still more preferably 5% or less.

Each of CaO, SrO, and BaO is a component that lowers the viscosity of the glass and enhances molding processability, and is an optional component. If the residual glass contains CaO, the content thereof is preferably 0.5% or more, and more preferably 1% or more. From the viewpoint of glass brittleness and chemical strengthening properties, the content of CaO in the residual glass is preferably 5% or less, more preferably 3% or less, and still more preferably 2% or less.

If the residual glass contains SrO, the content thereof is preferably 0.5% or more, and more preferably 1% or more. In order to maintain the chemical durability of the residual glass, the content of SrO in the residual glass is preferably 10% or less, and more preferably 5% or less.

If the residual glass contains BaO, the content thereof is preferably 0.5% or more, and more preferably 1% or more. In order to maintain the chemical durability of the residual glass, the content of BaO in the residual glass is preferably 10% or less, and more preferably 5% or less.

From the viewpoint of strength characteristics of the glass, the content of TiO₂ in the residual glass is preferably 0% or more, more preferably 0.1% or more, and still more preferably 1% or more. In order to prevent coloring of the glass, the content of TiO₂ in the residual glass is preferably 15% or less, more preferably 13% or less, and still more preferably 12% or less.

From the viewpoint of lowering the viscosity of the glass and improving moldability after crystallization, in the residual glass of the present glass ceramics, a ratio (MgO+CaO+SrO+BaO+Li₂O+Na₂O+K₂O)/(SiO₂+Al₂O₃+B₂O₃+P₂O₅) of a total content of MgO, CaO, SrO, BaO, Li₂O, Na₂O, and K₂O to a total content of SiO₂, Al₂O₃, B₂O₃, and P₂O₅ is preferably 0.45 or more, more preferably 0.48 or more, and still more preferably 0.50 or more. The upper limit is not particularly limited, but is preferably 0.80 or less, more preferably 0.70 or less, and still more preferably 0.65 or less from the viewpoint of the chemical durability of the glass.

From the viewpoint of improving the mechanical properties of the glass, in the residual glass of the present glass ceramics, a ratio Al₂O₃/(SiO₂+Al₂O₃+B₂O₃+P₂O₅) of a content of Al₂O₃ to the total content of SiO₂, Al₂O₃, B₂O₃, and P₂O₅ is preferably 0.08 or more, more preferably 0.09 or more, and still more preferably 0.10 or more. The upper limit is not particularly limited, but is preferably 0.31 or less, more preferably 0.30 or less, and still more preferably 0.29 or less from the viewpoint of moldability and chemical durability of the glass.

From the viewpoint of improving the mechanical properties of the glass, in the residual glass of the present glass ceramics, a ratio Al₂O₃/SiO₂ of the content of Al₂O₃ to a content of SiO₂ is preferably 0.1 or more, more preferably 0.13 or more, and still more preferably 0.15 or more. The upper limit is not particularly limited, but is preferably 0.6 or less, more preferably 0.5 or less, and still more preferably 0.45 or less from the viewpoint of moldability and chemical durability of the glass.

The following two examples are given as embodiments of the composition of the residual glass.

[Embodiment 1 of Residual Glass Composition] A composition in which a total content of SiO₂, Al₂O₃, B₂O₃, and P₂O₅ contained in the composition of the residual glass is 68% or more in terms of mol % based on oxides.

[Embodiment 2 of Residual Glass Composition] A composition in which a total content of SiO₂, Al₂O₃, B₂O₃, and P₂O₅ contained in the composition of the residual glass is 60% or less in terms of mol % based on oxides, and a parameter P representing an ion filling rate to be described later is 0.520 or more and 0.570 or less.

Hereinafter, each embodiment will be described.

[Embodiment 1 of Residual Glass Composition] A composition in which a total content of SiO₂, Al₂O₃, B₂O₃, and P₂O₅ contained in the composition of the residual glass is 68% or more in terms of mol % based on oxides.

In Embodiment 1, the total content of SiO₂, Al₂O₃, B₂O₃, and P₂O₅ contained in the composition of the residual glass is 68% or more, preferably 69% or more, and more preferably 70% or more. The glass ceramics are excellent not only in chemical durability but also in strength by having the total content of SiO₂, Al₂O₃, B₂O₃, and P₂O₅ of 68% or more. In Embodiment 1, the total content of SiO₂, Al₂O₃, B₂O₃, and P₂O₅ is, for example, preferably 90% or less, more preferably 89% or less, and still more preferably 88% or less, from the viewpoint of moldability after crystallization.

The parameter P in the specification is a parameter representing an ion filling rate of constituent elements of the residual glass, and affects the strength characteristics of the glass. The parameter P is calculated based on the following formula,

P=0.458×[SiO₂]+0.515×[Al₂O₃]+0.735×[B₂O₃]+0.586×[P₂O₅]+0.567×[MgO]+0.675×[CaO]+0.481×[SrO]+0.489×[BaO]+0.539×[Li₂O]+0.410×[Na₂O]+0.463×[K₂O]+0.701×[ZrO₂]+0.762×[TiO₂]+0.567×[La₂O₃]+0.552×[Y₂O₃]+0.544×[ZnO],

provided that [SiO₂], [Al₂O₃], [B₂O₃], [P₂O₅], [MgO], [CaO], [SrO], [BaO], [Li₂O], [Na₂O], [K₂O], [ZrO₂], [TiO₂], [La₂O₃], [Y₂O₃], and [ZnO] are respectively contents in the residual glass of SiO₂, Al₂O₃, B₂O₃, P₂O₅, MgO, CaO, SrO, BaO, Li₂O, Na₂O, K₂O, ZrO₂, TiO₂, La₂O₃, Y₂O₃, and ZnO, in terms of mol % based on oxides.

In Embodiment 1, the parameter P is preferably 0.495 or more, more preferably 0.497 or more, still more preferably 0.498 or more, and particularly preferably 0.500 or more. In Embodiment 1, if the parameter P is 0.495 or more, the Young's modulus of the residual glass can be increased to improve the strength of the glass.

In Embodiment 1, the parameter P is preferably 0.535 or less, more preferably 0.530 or less, and still more preferably 0.525 or less from the viewpoint of stability such as durability of the glass. In Embodiment 1, the parameter P is preferably 0.495 or more, more preferably 0.496 or more, and still more preferably 0.497 or more from the viewpoint of mechanical properties of the glass.

The parameter P can be adjusted by adjusting the content of each composition constituting the formula and crystallization conditions in the residual glass. Specifically, for example, by controlling the crystallization conditions, components such as Al₂O₃, B₂O₃, and ZrO₂ are left in the residual glass, and crystals mainly containing other components are precipitated, whereby P increases. On the other hand, if the residual glass contains a large amount of components such as SiO₂, Na₂O, and K₂O, P decreases.

[Embodiment 2 of Residual Glass Composition] A composition in which a total content of SiO₂, Al₂O₃, B₂O₃, and P₂O₅ contained in the composition of the residual glass is 60% or less in terms of mol % based on oxides, and a parameter P representing an ion filling rate to be described later is 0.520 or more and 0.570 or less.

In Embodiment 2, the total content of SiO₂, Al₂O₃, B₂O₃, and P₂O₅ contained in the composition of the residual glass is 60% or less, preferably 58% or less, and more preferably 56% or less. When the total content of SiO₂. Al₂O₃, B₂O₃, and P₂O₅ is 60% or less, the Young's modulus of the residual glass can be improved. In Embodiment 2, the total content of SiO₂, Al₂O₃, B₂O₃, and P₂O₅ is, for example, preferably 30% or more, more preferably 32% or more, and still more preferably 34% or more from the viewpoint of chemical durability.

In Embodiment 2, the parameter P is 0.520 or more, preferably 0.523 or more, and more preferably 0.525 or more from the viewpoint of mechanical properties of the glass. In Embodiment 2, the parameter P is 0.570 or less, preferably 0.560 or less, and more preferably 0.555 or less from the viewpoint of moldability and workability after crystallization of the glass.

<Base Glass>

The base glass of the glass ceramics of the present invention is not particularly limited, but is preferably a lithium aluminosilicate glass. That is, SiO₂, Al₂O₃, and Li₂O are preferably contained as main components of the base glass. Since the base glass is the lithium aluminosilicate glass, higher strength can be obtained by chemically strengthening by ion exchange treatment.

A base composition of the present glass ceramics preferably has the following composition in terms of mol % based on oxides:
30% to 80% of SiO₂;
3% to 35% of Al₂O₃;
0% to 35% of MgO;
0% to 30% of Li₂O;
0% to 10% of Na₂O;
0% to 3% of K₂O; and
0% to 10% of ZrO₂.

Hereinafter, a preferred composition will be described.

SiO₂ is a component constituting a glass network. SiO₂ is also a component for increasing chemical durability. The content of SiO₂ is preferably 30% or more, more preferably 32% or more, and still more preferably 35% or more. In order to increase meltability of the glass, the content of SiO₂ is preferably 80% or less, more preferably 77% or less, and still more preferably 75% or less.

Al₂O₃ is a component effective not only for improving the mechanical properties of the glass, but also for improving ion exchange properties during chemical strengthening and increasing a surface compressive stress after strengthening. The content of Al₂O₃ is preferably 3% or more, more preferably 4% or more, and still more preferably 5% or more. The content of Al₂O₃ is preferably 35% or less, more preferably 32% or less, and still more preferably 30% or less in order to increase the meltability.

Li₂O is a component not only for improving melting properties of the glass but also for improving the mechanical properties. In addition, chemical strengthening is also possible. Li₂O is an optional component, and the content of Li₂O when contained is preferably 1% or more, more preferably 3% or more, and still more preferably 5% or more in order to increase the melting properties of the glass and a depth of compressive stress layer DOL after chemical strengthening. In order to prevent occurrence of devitrification in the production of the glass, the content of Li₂O is preferably 30% or less, more preferably 27% or less, and still more preferably 25% or less.

Na₂O is a component for improving the melting properties of the glass, and is also a component that enables chemical strengthening. Na₂O is an optional component, and the content of Na₂O when contained is preferably 0.1% or more, more preferably 0.5% or more, and still more preferably 1.0% or more. The content of Na₂O is preferably 10% or less, more preferably 8% or less, and still more preferably 6% or less in order to maintain the chemical durability.

K₂O is a component for improving the meltability of the glass and promoting ion exchange during chemical strengthening. K₂O is an optional component, and the content of K₂O when contained is preferably 0.5% or more, and more preferably 1% or more. The content of K₂O is preferably 3% or less, more preferably 2% or less, and still more preferably 1% or less in order to maintain the chemical durability.

CaO, SrO, and BaO are all components for enhancing the meltability of the glass, but tend to lower the ion exchange performance. MgO, CaO, SrO and BaO are optional components, and when at least one of them is contained, a total content (MgO+CaO+SrO+BaO) is preferably 0.1% or more, and more preferably 0.5% or more.

MgO is a component for improving the melting properties and the mechanical properties of the glass, and is an optional component. The content of MgO when contained is preferably 1% or more, and more preferably 2% or more. The content of MgO is preferably 37% or less, more preferably 35% or less, and still more preferably 33% or less from the viewpoint of devitrification properties during melting of the glass.

The content of CaO when contained is preferably 0.5% or more, and more preferably 1% or more. In order to improve the ion exchange performance, the content of CaO is preferably 5% or less, and more preferably 3% or less.

The content of SrO when contained is preferably 0.5% or more, and more preferably 1% or more. In order to improve the ion exchange performance, the content of SrO is preferably 5% or less, and more preferably 3% or less.

The content of BaO when contained is preferably 0.5% or more, and more preferably 1% or more. In order to improve the ion exchange performance, the content of BaO is preferably 5% or less, and more preferably 1% or less.

ZnO is a component for improving the meltability of the glass, and may be contained. The content of ZnO when contained is preferably 0.2% or more, and more preferably 0.5% or more. In order to increase weather resistance of the glass, the content of ZnO is preferably 5% or less, and more preferably 3% or less.

TiO₂ is a component for improving the mechanical properties of the glass and increasing a surface compressive stress due to ion exchange, and may be contained. The content of TiO₂ when contained is preferably 0.1% or more, and more preferably 1% or more. The content of TiO₂ is preferably 12% or less, and more preferably 10% or less in order to prevent devitrification during melting. In order to avoid coloring of the glass, the content is preferably 5% or less, more preferably 3% or less, and still more preferably 1% or less, and it is further preferable that TiO₂ is not substantially contained.

ZrO₂ is a component for improving the mechanical properties of the glass and increasing a surface compressive stress during chemical strengthening, and is an optional component. The content of ZrO₂ is preferably 0.5% or more, and more preferably 1% or more. The content is preferably 13% or less, more preferably 12% or less, and still more preferably 10% or less in order to prevent devitrification during melting.

In a case where the glass is colored, a coloring component may be added as long as achievement of desired chemical strengthening properties is not inhibited. Examples of the coloring component include Co₃O4, MnO₂, Fe₂O₃, NiO, CuO, Cr₂O₃, V₂O₅, Bi₂O₃, SeO₂, CeO₂, Er₂O₃, and Nd₂O₃. These may be used alone or in combination thereof.

The content of the coloring component is preferably 7% or less in total. Accordingly, it is possible to prevent devitrification of the glass. The content of the coloring component is more preferably 5% or less, still more preferably 3% or less, and particularly preferably 1% or less. In a case where it is desired to increase visible light transmittance of the glass, it is preferable that these components are not substantially contained.

SO₃, a chloride, a fluoride, or the like may be appropriately contained as a refining agent or the like during melting of the glass. It is preferable that As₂O₃ is substantially not contained. In a case where Sb₂O₃ is contained, the content thereof is preferably 0.3% or less, and more preferably 0.1% or less, and it is most preferable that Sb₂O₃ is substantially not contained.

<Method for Producing Glass Ceramics>

The present glass ceramic is produced by subjecting the base glass to a heat treatment. The present glass ceramic is preferably subjected to a chemical strengthening treatment.

(Production of Base Glass)

An amorphous glass can be produced, for example, by the following method. The production method described below is an example of producing a sheet-shaped chemically strengthened glass.

In order to obtain a glass having a preferred composition, glass raw materials are blended, and then heated and melted in a glass melting furnace. Thereafter, the molten glass is homogenized by bubbling, stirring, addition of a refining agent, or the like and formed into a glass sheet having a predetermined thickness by a known forming method, followed by being annealed. Alternatively, the molten glass may be formed into a block shape, annealed, and then cut into a sheet shape.

Examples of methods for forming a sheet-shaped glass include a float method, a press method, a fusion method, and a down-draw method.

(Crystallization Treatment)

The base glass obtained by the above procedure is subjected to a heat treatment to obtain a glass ceramic.

The heat treatment is preferably performed in two stages in which the glass is held for a certain period of time at a temperature raised from room temperature to a first treatment temperature, and then is held for a certain period of time at a second treatment temperature that is higher than the first treatment temperature.

In the case of the two-stage heat treatment, the first treatment temperature is preferably a temperature range in which a crystal nucleation rate increases in the glass composition, and the second treatment temperature is preferably a temperature range in which a crystal growth rate increases in the glass composition. A holding time at the first treatment temperature is preferably kept long so that a sufficient number of crystal nuclei are generated. When a large number of crystal nuclei are generated, a size of each crystal is reduced, and glass ceramics having high transparency are obtained.

The first treatment temperature is, for example, 450° C. to 700° C., and the second treatment temperature is, for example, 600° C. to 800° C. The glass is held for 1 hour to 6 hours at the first treatment temperature and then is held for 1 hour to 6 hours at the second treatment temperature.

The glass ceramic obtained by the above procedure is subjected to grinding and polishing as necessary to form a glass ceramic sheet. In a case where the glass ceramic sheet is used after being subjected to a chemical strengthening treatment, it is preferable to perform cutting or chamfering before performing the chemical strengthening treatment because a compressive stress layer is also formed on an end surface by a subsequent chemical strengthening treatment.

(Chemical Strengthening Treatment)

The glass ceramic of the present invention may be subjected to a chemical strengthening treatment. The chemical strengthening treatment is a treatment in which, by a method of immersing the glass into a melt of a metal salt (for example, potassium nitrate) containing metal ions (typically, Na ions or K ions) having a large ionic radius, the glass is brought into contact with the metal salt, and thus metal ions having a small ionic radius (typically, Na ions or Li ions) in the glass are substituted with the metal ions having a large ionic radius (typically, Na ions or K ions for Li ions, and K ions for Na ions).

In order to increase a rate of the chemical strengthening treatment, it is preferable to use “Li—Na exchange” in which Li ions in the glass are exchanged with Na ions. In addition, in order to form a large compressive stress by ion exchange, it is preferable to use “Na—K exchange” in which Na ions in the glass are exchanged with K ions.

Examples of the molten salt for performing the chemical strengthening treatment include a nitrate, a sulfate, a carbonate, a chloride, and the like. Examples of the nitrate include lithium nitrate, sodium nitrate, potassium nitrate, cesium nitrate, silver nitrate, and the like. Examples of the sulfate include lithium sulfate, sodium sulfate, potassium sulfate, cesium sulfate, silver sulfate, and the like. Examples of the carbonate include lithium carbonate, sodium carbonate, potassium carbonate, and the like. Examples of the chloride include lithium chloride, sodium chloride, potassium chloride, cesium chloride, silver chloride, and the like. These molten salts may be used alone or in combination thereof.

As the treatment conditions of the chemical strengthening treatment, time, temperature, and the like may be appropriately selected in consideration of the glass composition, the type of molten salt, and the like.

The present strengthened glass is preferably obtained by, for example, the following two-stage chemical strengthening treatment.

First, the present glass ceramic is immersed in a metal salt (for example, sodium nitrate) containing Na ions at about 350° C. to 500° C. for about 0.1 to 10 hours. This causes ion exchange between Li ions in the glass ceramic and Na ions in the metal salt, and for example, a compressive stress layer having a surface compressive stress value of 200 MPa or more and a depth of compressive stress layer of 80 μm or more can be formed.

The chemically strengthened glass (present strengthened glass) obtained by chemically strengthening the present glass ceramic preferably has a surface compressive stress value of 200 MPa or more, more preferably 250 MPa or more. When the surface compressive stress value is 200 MPa or more, the breakage due to deformation such as bending is less likely to occur.

The present strengthened glass preferably has a depth of compressive stress layer DOL of 50 μm or more, more preferably 80 μm or more, and still more preferably 100 μm or more. When DOL is 50 μm or more, the breakage is less likely to occur even when flaws are generated on the surface.

By immersing the present glass ceramic in a metal salt containing Na ions and Li ions, the ion exchange between Na ions in the glass and Li ions in the metal salt occurs, a more preferable stress profile is formed, and thus asphalt drop strength is increased.

In order to increase the asphalt drop strength, a compressive stress value CS50 at a depth of 30 μm is preferably 100 MPa or more, more preferably 140 MPa or more, and still more preferably 160 MPa or more.

Here, the asphalt drop strength can be evaluated by the following asphalt drop test.

(Asphalt Drop Test)

A glass sheet (120 mm×60 mm×0.8 mm) to be evaluated is regarded as a cover glass of a smartphone, attached to a housing that simulates the smartphone, and dropped on a flat asphalt surface. The total mass of the glass sheet and the housing is about 140 g.

The test is started from a height of 30 cm. If the chemically strengthened glass sheet is not broken, the test is repeated by increasing the height by 10 cm and dropping the chemically strengthened glass sheet, and then a height [unit: cm] at which the glass sheet is broken is recorded. The test is taken as one set, and 10 sets are repeated, and then an average value of heights at the time of breaking is taken as a “drop height”. The drop height of the present strengthened glass in the asphalt drop test is preferably 100 cm or more.

The present strengthened glass is also useful as a cover glass used in an electronic device such as a mobile device such as a mobile phone or a smartphone. Furthermore, the present strengthened glass is also useful for a cover glass of an electronic device such as a television, a personal computer, and a touch panel, an elevator wall surface, or a wall surface (full-screen display) of a construction such as a house and a building, which are not intended to be carried. In addition, the present strengthened glass is also useful as a building material such as a window glass, a table top, an interior of an automobile, an airplane, or the like, and a cover glass thereof, or a casing having a curved surface shape.

Since the present strengthened glass has good high-frequency characteristics, the present strengthened glass is suitable for a cover glass of a high-frequency communication device.

### Examples

Hereinafter, the present invention will be described with reference to Examples, but the present invention is not limited thereto.

<Production of Amorphous Glass>

Glass raw materials were blended so as to have a glass composition shown in Table 1 in terms of mol % based on oxides, and weighed out to obtain 800 g of glass. Next, the mixed glass raw materials were put in a platinum crucible, put into an electric furnace at 1600° C. melted for about 5 hours, defoamed, and then homogenized.

The obtained molten glass was poured into a mold, held at a temperature of a glass transition point for 1 hour, and then cooled to room temperature at a rate of 0.5° C./min to obtain a glass block.

The glass having the composition shown in Table 1 is heat-treated to obtain glass ceramics. In Table 1, a blank denotes that a component is not contained.

TABLE 1

| | Glass 1 | Glass 2 | Glass 3 | Glass 4 | Glass 5 | Glass 6 | Glass 7 | Glass 8 | Glass 9 |
|---|---|---|---|---|---|---|---|---|---|
| SiO₂ | 69.66 | 70.69 | 58.4 | 67.0 | 63.0 | 59.0 | 63.5 | 51.5 | 38 |
| Al₂O₃ | 14.6 | 4.3 | 19.4 | 13.0 | 17.0 | 5.0 | 6.0 | 27.0 | 13 |
| B₂O₃ | | 0.02 | | | 3 | | 1 | 2 | |
| P₂O₅ | 1.41 | 0.89 | | 1 | 1 | 2 | 2.5 | | |
| MgO | | | 14.2 | 2.0 | | 7 | | 12 | 32 |
| CaO | | | | | | | | | |
| SrO | | | | | | | | | |
| BaO | 0.43 | | | | 0.5 | | | | |
| Li₂O | 9.57 | 20.94 | 5 | 11 | 11 | 22 | 23 | | |
| Na₂O | 2.15 | 1.39 | | 1 | 1.5 | 2 | 1.5 | | |
| K₂O | 0.92 | 0.02 | | | 0.8 | | | | |
| ZrO₂ | 1.24 | 1.77 | | 2 | 2.2 | 2 | 2.5 | 2.5 | 5 |
| TiO₂ | | | 3 | 2 | | 1 | | 5 | 10 |
| La₂O₃ | | | | | | | | | |
| Y₂O₃ | | | | 1 | | | | | 2 |
| ZnO | | | | | | | | | |

<Crystallization Treatment and Evaluation of Glass Ceramics>

For glasses 1 to 9, the obtained glass block was processed into a size of 50 mm×50 mm×1.5 mm, and then heat-treated under conditions described in Tables 2 and 3 to obtain glass ceramics. The obtained glass ceramics were processed and mirror-polished to obtain a glass ceramic sheet having a thickness t of 0.7 mm.

In the columns of the crystallization conditions in the Tables 2 and 3, the upper row (heat treatment 1) is nucleation treatment conditions and the lower row (heat treatment 2) is crystal growth treatment conditions. For example, in a case where the upper row describes 650° C., and 2 h and the lower row describes 850° C., and 2 h, it means that the glass is held at 650° C. for 2 hours and then held at 850° C. for 2 hours. Examples 1 and 2 are comparative examples, and Examples 3 to 9 are working examples. In the column of crystallization conditions in Table 3, a blank denotes that the obtained glass block was processed into the size of 50 mm×50 mm×1.5 mm, and then was not subjected to a heat treatment for crystallization.

(X-Ray Diffraction: Precipitated Crystals)

A part of the glass ceramic was pulverized, and powder X-ray diffraction was measured under the following conditions to identify precipitated crystals. The crystallization rate was calculated from the obtained diffraction intensity by the Rietveld method. The results are shown in Tables 2 and 3. The residual glass composition in terms of mol % based on oxides is shown in the columns of SiO₂ to Y₂O₃ in Tables 2 and 3. In the column of the residual glass composition and the column of the crystal in Tables 2 and 3, a blank denotes that a component is not contained.
Measurement device: SmartLab manufactured by Rigaku Corporation
X-ray used: CuKα ray
Measurement range: 20=10° to 80°
Speed: 10°/min
Step: 0.02°

The terms in Tables 2 and 3 are described below.
NWF: the total content of SiO₂, Al₂O₃, B₂O₃, and P₂O₅ in the residual glass
Al/NWF: the ratio of the content of Al₂O₃ to the total content of SiO₂, Al₂O₃, B₂O₃, and P₂O₅ in the residual glass
Al/Si: the ratio of the content of Al₂O₃ to the content of SiO₂ in the residual glass
NWM: the total content of MgO, CaO, SrO, BaO, Li₂O, Na₂O, and K₂O in the residual glass
Young's modulus parameter ER: the Young's modulus parameter ER is calculated based on the following formula,

ER=62.2×[SiO₂]+134.9×[Al₂O₃]+121.7×[B₂O₃]+33.0×[P₂O₅]+72.6×[MgO]+121.5×[CaO]+43.7×[SrO]+38.6×[BaO]+84.0×[Li₂O]+26.2×[Na₂O]+17.8×[K₂O]+156.8×[ZrO₂]+154.3×[TiO₂]+74.7×[La₂O₃]+80.3×[Y₂O₃]+54.3×[ZnO],

provided that [SiO₂], [Al₂O₃], [B₂O₃], [P₂O₅], [MgO], [CaO], [SrO], [BaO], [Li₂O], [Na₂O], [K₂O], [ZrO₂], [TiO₂], [La₂O₃], [Y₂O₃], and [ZnO] are respectively contents in the residual glass of SiO₂, Al₂O₃, B₂O₃, P₂O₅, MgO, CaO, SrO, BaO, Li₂O, Na₂O, K₂O, ZrO₂, TiO₂, La₂O₃, Y₂O₃, and ZnO, in terms of mol % based on oxides.

Parameter P: the parameter P is calculated based on the following formula,

P=0.458×[SiO₂]+0.515×[Al₂O₃]+0.735×[B₂O₃]+0.586×[P₂O₅]+0.567×[MgO]+0.675×[CaO]+0.481×[SrO]+0.489×[BaO]+0.539×[Li₂O]+0.410×[Na₂O]+0.463×[K₂O]+0.701×[ZrO₂]+0.762×[TiO₂]+0.567×[La₂O₃]+0.552×[Y₂O₃]+0.544×[ZnO],

provided that [SiO₂], [Al₂O₃], [B₂O₃], [P₂O₅], [MgO], [CaO], [SrO], [BaO], [Li₂O], [Na₂O], [K₂O], [ZrO₂], [TiO₂], [La₂O₃], [Y₂O₃], and [ZnO] are respectively contents in the residual glass of SiO₂, Al₂O₃, B₂O₃, P₂O₅, MgO, CaO, SrO, BaO, Li₂O, Na₂O, K₂O, ZrO₂, TiO₂, La₂O₃, Y₂O₃, and ZnO, in terms of mol % based on oxides.

TABLE 2

| | | Example | Example | Example | | |
|---|---|---|---|---|---|---|
| | | 1 | 2 | 3 | Example 4 | Example 5 |
| Base glass | | Glass 1 | Glass 2 | Glass 3 | Glass 4 | Glass 5 |
| Residual | SiO₂ | 57.85 | 50.89 | 57.24 | 61.87 | 45.78 |
| glass | Al₂O₃ | 4.19 | 1.65 | 18.97 | 12.05 | 14.64 |
| | B₂O₃ | 0.00 | 0.21 | 0.00 | 0.00 | 7.66 |
| | P₂O₅ | 5.18 | 9.50 | 0.00 | 1.44 | 2.55 |
| | MgO | 0.00 | 0.00 | 10.48 | 2.87 | 0.00 |
| | CaO | 0.00 | 0.00 | 0.00 | 0.00 | 0.00 |
| | SrO | 0.00 | 0.00 | 0.00 | 0.00 | 0.00 |
| | BaO | 1.58 | 0.00 | 0.00 | 0.00 | 1.28 |
| | Li₂O | 20.31 | 3.80 | 8.32 | 13.82 | 19.46 |
| | Na₂O | 2.95 | 14.84 | 0.00 | 0.77 | 0.95 |
| | K₂O | 3.38 | 0.21 | 0.00 | 0.00 | 2.04 |
| | ZrO₂ | 4.56 | 18.90 | 0.00 | 2.87 | 5.62 |
| | TiO₂ | | | 4.99 | 2.87 | |
| | La₂O₃ | | | | 0.00 | |
| | Y₂O₃ | | | | 1.44 | |
| | ZnO | | | | | |
| | NWF | 67.2 | 62.3 | 76.2 | 75.4 | 70.6 |
| | Al/NWF | 0.062 | 0.026 | 0.249 | 0.160 | 0.207 |
| | Al/Si | 0.072 | 0.032 | 0.331 | 0.195 | 0.320 |
| | NWM | 28.221 | 18.849 | 18.802 | 17.464 | 23.739 |
| | NWM/NWF | 0.420 | 0.303 | 0.247 | 0.232 | 0.336 |
| | Young's modulus parameter ER | 69.6 | 74.0 | 83.5 | 79.2 | 84.7 |
| | Parameter P | 0.494 | 0.513 | 0.502 | 0.498 | 0.520 |
| Crystallization | Heat treatment 1 Temperature (° C.) | 750 | 570 | 760 | 550 | 650 |
| condition | Heat treatment 1 Time (hr) | 4 | 4 | 2 | 4 | 3 |
| | Heat treatment 2 Temperature (° C.) | 900 | 725 | 840 | 700 | 850 |
| | Heat treatment 2 Time (hr) | 4 | 1.5 | 2 | 2 | 1.5 |
| Crystal (wt %) | Li₃PO₄ | | | | | |
| | Li₂SiO₃ | | | | | |
| | Li₂Si₂O₅ | | 43 | | | |
| | SiO₂(Crystobalite) | | | | 5 | |
| | β-Spodumene-ss | 73 | | | 25 | 60 |
| | LiAlSi₄O₁₀ | | 44 | | | |
| | LiAlSi₃O₆(β-Quartz) | | | | | |
| | MgAl₂Si₃O₁₀ | | | 40 | | |
| | MgAl₂O₄ | | | | | |
| | Sapphirine | | | | | |
| | ZrO₂ | | | | | |

| | | | | | |
|---|---|---|---|---|---|
| Crystallization rate (wt %) | 73 | 87 | 40 | 30 | 60 |
| Residual glass rate (wt %) | 27 | 13 | 60 | 70 | 40 |

TABLE 3

| | | Example 6 | Example 7 | Example 8 | Example 9 |
|---|---|---|---|---|---|
| Base glass | | Glass 6 | Glass 7 | Glass 8 | Glass 9 |
| Residual | SiO₂ | 60.05 | 51.8 | 59.7 | 40.24 |
| glass | Al₂O₃ | 10.84 | 12.1 | 24.6 | 13.76 |
| | B₂O₃ | 0.00 | 2.8 | 3.2 | 0.00 |
| | P₂O₅ | 0.58 | 6.9 | 0.0 | 0.00 |
| | MgO | 15.18 | 0.0 | 0.5 | 32.82 |
| | CaO | 0.00 | 0.0 | 0.0 | 0.00 |
| | SrO | 0.00 | 0.0 | 0.0 | 0.00 |
| | BaO | 0.00 | 0.0 | 0.0 | 0.00 |
| | Li₂O | 2.50 | 15.3 | 0.0 | 0.00 |
| | Na₂O | 4.34 | 4.2 | 0.0 | 0.00 |
| | K₂O | 0.00 | 0.0 | 0.0 | 0.00 |
| | ZrO₂ | 4.34 | 6.9 | 4.0 | 0.47 |
| | TiO₂ | 2.17 | | 8.0 | 10.59 |
| | La₂O₃ | 0.00 | | | 0.00 |
| | Y₂O₃ | 0 | | | 2.12 |
| | ZnO | | | | |
| | NWF | 71.5 | 73.6 | 87.5 | 54.0 |
| | Al/NWF | 0.152 | 0.164 | 0.281 | 0.255 |
| | Al/Si | 0.181 | 0.233 | 0.411 | 0.342 |
| | NWM | 22.016 | 19.486 | 0.544 | 32.824 |
| | NWM/NWF | 0.308 | 0.265 | 0.006 | 0.608 |
| | Young's modulus parameter ER | 76.6 | 79.0 | 93.2 | 86.2 |
| | Parameter P | 0.498 | 0.509 | 0.515 | 0.537 |
| Crystallization | Heat treatment 1 Temperature (° C.) | 550 | 570 | 660 | |
| condition | Heat treatment 1 Time (hr) | 2 | 2 | 3 | |
| | Heat treatment 2 Temperature (° C.) | 710 | 725 | 720 | |
| | Heat treatment 2 Time (hr) | 2 | 2 | 1 | |
| Crystal (wt %) | Li₃PO₄ | 7 | | | |
| | Li₂SiO₃ | | | | |
| | Li₂Si₂O₅ | 44 | 40 | | |
| | SiO₂(Crystobalite) | | | | |
| | β-Spodumene-ss | | | | |
| | LiAlSi₄O₁₀ | | 17 | | |
| | LiAlSi₃O₆(β-Quartz) | | | | |
| | MgAl₂Si₃O₁₀ | | | | |
| | MgAl₂O₄ | | | 2 | |
| | Sapphirine | | | 33 | |
| | ZrO₂ | | | | 10 |

| | | | | |
|---|---|---|---|---|
| Crystallization rate (wt %) | 51 | 57 | 35 | 10 |
| Residual glass rate (wt %) | 49 | 43 | 65 | 90 |

As shown in Tables 2 and 3, in Examples 3 to 8, which are working examples, the Young's modulus parameter ER of the residual glass is 75 or more, and it is possible to control the brittleness of the residual glass to prevent the occurrence of the crack that is a fracture starting point and the crack propagation, and thus the strength is excellent compared to the comparative examples.

As described above, in particular, the characteristics of crack propagation are directly linked to fracture, and the fracture stress of the glass can be expressed by the following formula (γ is fracture surface energy, E is Young's modulus, and c is a length of a crack). σf=√(2γE/πc)

Since it is very difficult to greatly change the fracture surface energy γ by changing the composition of the glass, it is very effective to control the Young's modulus parameter ER having a positive correlation with the Young's modulus in order to improve the fracture stress.

Although the present invention has been described in detail with reference to specific aspects, it is apparent to those skilled in the art that various changes and modifications can be made without departing from the spirit and scope of the present invention.

Although the present invention has been described in detail with reference to specific aspects, it is apparent to those skilled in the art that various changes and modifications can be made without departing from the spirit and scope of the present invention. The present application is based on a Japanese patent application (No. 2021-018363) filed on Feb. 8, 2021, the entire contents of which are incorporated herein by reference. In addition, all references cited here are entirely incorporated.

What is claimed is:

1. A glass ceramic comprising a crystal and a residual glass,
wherein the residual glass has a Young's modulus parameter ER of 75 or more, the Young's modulus parameter ER being calculated based on the following formula:
ER=62.2×[SiO₂]+134.9×[Al₂O₃]+121.7×[B₂O₃]+33.0×[P₂O₅]+72.6×[MgO]+121.5×[CaO]+43.7×[SrO]+38.6×[BaO]+84.0×[Li₂O]+26.2×[Na₂O]+17.8×[K₂O]+156.8×[ZrO₂]+154.3×[TiO₂]+74.7×[La₂O₃]+80.3×[Y₂O₃]+54.3×[ZnO],
provided that [SiO₂], [Al₂O₃], [B₂O₃], [P₂O₅], [MgO], [CaO], [SrO], [BaO], [Li₂O], [Na₂O], [K₂O], [ZrO₂], [TiO₂], [La₂O₃], [Y₂O₃], and [ZnO] are respectively contents in the residual glass of SiO₂, Al₂O₃, B₂O₃, P₂O₅, MgO, CaO, SrO, BaO, Li₂O, Na₂O, K₂O, ZrO₂, TiO₂, La₂O₃, Y₂O₃, and ZnO, in terms of mol % based on oxides.

2. The glass ceramic according to claim 1,
wherein the residual glass has a composition comprising, in terms of mol % based on oxides:
30% to 70% of SiO₂;
5% to 30% of Al₂O₃;
0% to 15% of B₂O₃;
0% to 10% of P₂O₅;
0% to 40% of MgO;
0% to 25% of Li₂O;
0% to 15% of Na₂O; and
0% to 15% of ZrO₂.

3. The glass ceramic according to claim 1, having a crystallization rate of 10 mass % to 90 mass %.

4. The glass ceramic according to claim 1,
wherein a total content of SiO₂, Al₂O₃, B₂O₃, and P₂O₅ contained in the composition of the residual glass is 68% or more in terms of mol % based on oxides.

5. The glass ceramic according to claim 1,
wherein the residual glass has a parameter P of 0.495 or more and 0.535 or less, the parameter P being calculated based on the following formula:
P=0.458×[SiO₂]+0.515×[Al₂O₃]+0.735×[B₂O₃]+0.586×[P₂O₅]+0.567×[MgO]+0.675×[CaO]+0.481×[SrO]+0.489×[BaO]+0.539×[Li₂O]+0.410×[Na₂O]+0.463×[K₂O]+0.701×[ZrO₂]+0.762×[TiO₂]+0.567×[La₂O₃]+0.552×[Y₂O₃]+0.544×[ZnO],
provided that [SiO₂], [Al₂O₃], [B₂O₃], [P₂O₅], [MgO], [CaO], [SrO], [BaO], [Li₂O], [Na₂O], [K₂O], [ZrO₂], [TiO₂], [La₂O₃], [Y₂O₃], and [ZnO] are respectively contents in the residual glass of SiO₂, Al₂O₃, B₂O₃, P₂O₅, MgO, CaO, SrO, BaO, Li₂O, Na₂O, K₂O, ZrO₂, TiO₂, La₂O₃, Y₂O₃, and ZnO, in terms of mol % based on oxides.

6. The glass ceramic according to claim 1,
wherein a total content of SiO₂, Al₂O₃, B₂O₃, and P₂O₅ contained in the composition of the residual glass is 60% or less in terms of mol % based on oxides, and
the residual glass has a parameter P of 0.520 or more and 0.570 or less, the parameter P being calculated based on the following formula:
P=0.458×[SiO₂]+0.515×[Al₂O₃]+0.735×[B₂O₃]+0.586×[P₂O₅]+0.567×[MgO]+0.675×[CaO]+0.481×[SrO]+0.489×[BaO]+0.539×[Li₂O]+0.410×[Na₂O]+0.463×[K₂O]+0.701×[ZrO₂]+0.762×[TiO₂]+0.567×[La₂O₃]+0.552×[Y₂O₃]+0.544×[ZnO],
provided that [SiO₂], [Al₂O₃], [B₂O₃], [P₂O₅], [MgO], [CaO], [SrO], [BaO], [Li₂O], [Na₂O], [K₂O], [ZrO₂], [TiO₂], [La₂O₃], [Y₂O₃], and [ZnO] are respectively contents in the residual glass of SiO₂, Al₂O₃, B₂O₃, P₂O₅, MgO, CaO, SrO, BaO, Li₂O, Na₂O, K₂O, ZrO₂, TiO₂, La₂O₃, Y₂O₃, and ZnO, in terms of mol % based on oxides.

7. The glass ceramic according to claim 6,
wherein a ratio (MgO+CaO+SrO+BaO+Li₂O+Na₂O+K₂O)/(SiO₂+Al₂O₃+B₂O₃+P₂O₅) of a total content of MgO, CaO, SrO, BaO, Li₂O, Na₂O, and K₂O to a total content of SiO₂, Al₂O₃, B₂O₃, and P₂O₅ in the residual glass in terms of mol % based on oxides is 0.45 or more.

8. The glass ceramic according to claim 1,
wherein a ratio Al₂O₃/(SiO₂+Al₂O₃+B₂O₃+P₂O₅) of a content of Al₂O₃ to the total content of SiO₂, Al₂O₃, B₂O₃, and P₂O₃ in the residual glass in terms of mol % based on oxides is 0.08 or more.

9. The glass ceramic according to claim 1,
wherein a ratio Al₂O₃/SiO₂ of the content of Al₂O₃ to a content of SiO₂ in the residual glass in terms of mol % based on oxides is 0.1 or more.

10. The glass ceramic according to claim 1, having a haze value in terms of a thickness of 0.7 mm of 1% or less, and a light transmittance in terms of a thickness of 0.7 mm of 85% or more.

11. The glass ceramic according to claim 1,
wherein a base glass of the glass ceramic is a lithium aluminosilicate glass.

12. A chemically strengthened glass comprising a compressive stress layer on a surface thereof, and
having a surface compressive stress of 200 MPa or more and a depth of a compressive stress layer of 80 μm or more,
wherein the chemically strengthened glass is a glass ceramic comprising a crystal and a residual glass,
the residual glass has a Young's modulus parameter ER of 75 or more, the Young's modulus parameter ER being calculated based on the following formula:
ER=62.2×[SiO₂]+134.9×[Al₂O₃]+121.7×[B₂O₃]+33.0×[P₂O₅]+72.6×[MgO]+121.5×[CaO]+43.7×[SrO]+38.6×[BaO]+84.0×[Li₂O]+26.2×[Na₂O]+17.8×[K₂O]+156.8×[ZrO₂]+154.3×[TiO₂]+74.7×[La₂O₃]+80.3×[Y₂O₃]+54.3×[ZnO],
provided that [SiO₂], [Al₂O₃], [B₂O₃], [P₂O₅], [MgO], [CaO], [SrO], [BaO], [Li₂O], [Na₂O], [K₂O], [ZrO₂], [TiO₂], [La₂O₃], [Y₂O₃], and [ZnO] are respectively contents in the residual glass of SiO₂, Al₂O₃, B₂O₃, P₂O₅, MgO, CaO, SrO, BaO, Li₂O, Na₂O, K₂O, ZrO₂, TiO₂, La₂O₃, Y₂O₃, and ZnO, in terms of mol % based on oxides.
